(19) United States
(12) Patent Application Publication
(10) Pub. No.: US 2017/0206325 A1
(43) Pub. Date: Jul. 20, 2017

(54) System, Method and Computer Program Product for Real Time Monitoring, Assignment and Balancing of Processional Oversight

(71) Applicant: NuVasive, Inc., San Diego, CA (US)

(72) Inventors: Richard A. O'Brien, Westminster, MD (US); David Ferrell, Nepean (CA)

(21) Appl. No.: 15/478,768

(22) Filed: Apr. 4, 2017

Related U.S. Application Data
(63) Continuation of application No. 12/332,728, filed on Dec. 11, 2008, now abandoned.
Application No. 12/332,728 is a continuation-in-part of application No. 12/167,818, filed on Jul. 3, 2008, now abandoned.

(51) Int. Cl. G06F 19/00

(52) U.S. Cl. CPC G06F 19/327; G06F 19/3418; G06F 19/3425; G06F 19/3481

(57) ABSTRACT

A system, method and computer program product for monitoring in real time, activities of a monitoring individual during remote connection and oversight of intra-operative neurophysiologic monitoring (IONM) data from a plurality of IONM devices of at least one machine type, including receiving IONM data from at least one IONM device regarding a surgery being monitored, receiving patient data about at least one patient, storing case data in a computer database, the case data including information regarding at least one of the patient data or the IONM data, scheduling the monitoring individual to a specific surgery case based on the case data, and providing the case data to the monitoring individual.

### CROSS REFERENCE TO RELATED APPLICATIONS

The present invention is a continuation of, and is related to, co-pending U.S. Non-Provisional patent application Ser. No. 12/332,728, filed Dec. 11, 2008, which is a continuation-in-part of, and is related to, abandoned U.S. Patent Application of U.S. Non-Provisional patent application Ser. No. 12/167,818, filed Jul. 3, 2008 to O'BRIEN et al., of common assignee to the present invention, the contentes of which are incorporated herein by reference in their entireties, and to which priority benefit is claimed.

### BACKGROUND

### Field of the Invention

The present invention relates generally to the process of managing services and more particularly to the process of managing intraoperative monitoring.

### SUMMARY OF THE INVENTION

An exemplary embodiment of the present invention sets forth a system, method and/or computer program product which may be used for real time monitoring, assigning and balancing of work load between more than one overseeing physician or other personnel connected to one or more neuromonitoring technologists or other personnel located at one or more remote sites.

An exemplary embodiment of the invention sets forth a computer-implemented method of monitoring in real time, activities of a monitoring individual during remote connection and oversight of intra-operative neurophysiologic monitoring (IONM) data from a plurality of IONM devices of at least one machine type. According to an exemplary embodiment, the method may include: receiving IONM data from at least one IONM device regarding a surgery being monitored; receiving, patient data about at least one patient; storing case data in a computer database, where case data includes information regarding at least the patient data or the IONM data; scheduling the monitoring individual to a specific surgery case based on the case data; and providing the case data to the monitoring individual.

According to one exemplary embodiment, the method may further include providing the case data stored in the database for analysis.

According to one exemplary embodiment, the method may further include analyzing the case data.

According to one exemplary embodiment, the method may further include communicating alarms generated based on the case data stored in the database.

According to one exemplary embodiment, the method may further include communicating alarms triggered by the monitoring individual.

According to one exemplary embodiment, the method may further include receiving or storing comments regarding the surgery made by at least one monitoring individual.

According to one exemplary embodiment, the method may further include interactively constructing a patient record during the surgery using at least one of the patient data, the IONM data, or the case data.

According to one exemplary embodiment, the method may further include creating a report on the surgery using the case data stored in the database.

According to one exemplary embodiment, the method may further include verifying monitoring by the monitoring individual by measuring data collection time and activity, including one or more of: a connection time; a communication interactions; a response to one or more prompts; or a parameter related to monitoring.

According to one exemplary embodiment, the monitoring individual may include at least one of: a technician; a technologist; a neurophysiologist; one or more intraoperative personnel; a physician; a surgeon; a provider; a care giver; a medical professional; or an overseeing physician.

According to one exemplary embodiment, the case data may include information regarding key events identified during the surgery being monitored.

According to one exemplary embodiment, the case data may include at least one of a stage of surgery or patient billing information.

According to one exemplary embodiment, the case data may include at least one of a stage of surgery or patient identification information.

According to one exemplary embodiment, the case data may include at least one of: a type of IONM device; a type of device implanted in a patient; clinical information; patient information; patient identification information; patient billing information; billing information; insurance information; demographic information; medical record data; a surgeon name; surgeon information; physician information; neurophysiologist information; early outcome data; preoperative data; post-operative data; outcome scales; outcomes allowed; IONM event data; IONM event data tied to preoperative condition; IONM event data tied to postoperative condition; baseline data; IONM baseline data; anesthesiology data; changes in anesthesiology data; baseline anesthesiology data; ongoing anesthesiology data; scale preoperative data; scale postoperative data; an alarm; a key event during the surgery including at least one of: loss of signal; anesthetic affect on data; change in neurophysiological data suggesting patient injury; signal recovered; or excessive noise; a key point of the surgery including at least one of: patient prep; opening; decompression of the spine; derotation of the spine; insertion of equipment; surgical manipulation; any major surgical intervention; any significant surgical intervention; closing; or case complete; a comment made regarding the surgery; or other information regarding the surgery being monitored.

According to one exemplary embodiment, the scheduling may include assigning cases to the overseeing individual at least one of: automatically without user interaction, by advising a user in making a selection, or semi-automatically with little user interaction.

According to one exemplary embodiment, the scheduling may include assigning cases based on at least one of: number or type of active cases; number or type of upcoming cases; active physicians; scheduled physicians; physician credentials; physician licensures; physician consulting privileges; geographic location of the surgery; stage of the surgery; key points of the surgery; key events during the surgery; efficiency improvement; quality of care improvement; compliance to legal requirements; or compliance to clinical requirements.

An exemplary embodiment of the invention sets forth a computer program product embodied on a machine readable medium, the computer program product including logic which when executed on a processor, may perform a method of monitoring in real time, activities of a monitoring individual during remote connection and oversight of intra-operative neurophysiologic monitoring (IONM) data from a plurality of IONM devices of at least one machine type. According to one exemplary embodiment, the method may further include: receiving IONM data from at least one IONM device regarding a surgery being monitored; receiving patient data about at least one patient; storing case data in a computer database, where the case data may include information regarding at least the patient data or the IONM data; scheduling the monitoring individual to a specific surgery case based on the case data; and providing the case data to the monitoring individual.

An exemplary embodiment of the invention sets forth a system for monitoring in real time, activities of a monitoring individual during remote connection and oversight of intra-operative neurophysiologic monitoring (IONM) data from a plurality of IONM devices of at least one machine type. According to one exemplary embodiment, the system may include a first means for receiving IONM data from at least one IONM device regarding a surgery being monitored; a second means for receiving patient data about at least one patient; means for storing case data in a computer database, where the case data may include information regarding at least the patient data or the IONM data; means for scheduling the monitoring individual to a specific surgery case based on the case data; and means for providing the case data to the monitoring individual.

According to another exemplary embodiment, a graphical user interface (GUI) application embodied on a computer readable medium is set forth. According to one exemplary embodiment, the application, when executed on a processor, may perform a method of scheduling intra-operative neurophysiologic monitoring (IONM) cases, the method including: receiving a schedule of a plurality of cases, where the schedule may include case data from a computer database, where the case data may include patient data and IONM data from at least one IONM device regarding, a surgery being monitored by at least one monitoring individual; and displaying at least a portion of the schedule to the monitoring individual.

According to one exemplary embodiment, the case data may include at least one of: a type of IONM device; a type of device implanted in a patient; clinical information; patient information; patient identification information; patient billing information; billing information; insurance information; demographic information; medical record data; a surgeon name; surgeon information; physician information; neurophysiologist information; early outcome data; preoperative data; post-operative data; outcome scales; outcomes allowed; IONM event data; IONM event data tied to preoperative condition; IONM event data tied to postoperative condition; baseline data; IONM baseline data; anesthesiology data; changes in anesthesiology data; baseline anesthesiology data; ongoing anesthesiology data; scale preoperative data; scale postoperative data; an alarm; a key event during the surgery including at least one of: loss of signal; anesthetic affect on data; change in neurophysiological data suggesting patient injury; signal recovered; or excessive noise; a key point of the surgery including at least one of: patient prep; opening; decompression of the spine; derotation of the spine; insertion of equipment; surgical manipulation; any major surgical intervention; any significant surgical intervention; closing; or case complete; a comment made regarding the surgery; or other information regarding the surgery being monitored.

According to one exemplary embodiment, displaying may include displaying active and inactive surgery cases to the monitoring individual.

According to one exemplary embodiment, the GUI may further include receiving information from the monitoring individual regarding the surgery being monitored.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a data flow diagram according to an exemplary embodiment of the present invention;

FIG. 2 depicts an exemplary embodiment of a logical system architecture according to an exemplary embodiment of the present invention;

FIG. 3 depicts an exemplary embodiment of a diagram of the use of multiple interface sessions according to an exemplary embodiment of the present invention;

FIG. 4 depicts an exemplary embodiment of a user interface of an overseeing physician according to an exemplary embodiment of the present invention;

FIG. 5 depicts an exemplary embodiment of a flow chart of a case start according to an exemplary embodiment of the present invention;

FIG. 6 depicts an exemplary embodiment of a sequence diagram for viewing, accepting and updating a case according to an exemplary embodiment of the present invention; and

FIG. 7 depicts an exemplary embodiment of a computer environment according to an exemplary embodiment of the present invention.

### DETAILED DESCRIPTION OF VARIOUS EXEMPLARY EMBODIMENTS OF THE PRESENT INVENTION

Various exemplary embodiments of the invention including preferred embodiments are discussed in detail below. While specific exemplary embodiments are discussed, it should be understood that this is done for illustration purposes only. A person skilled in the relevant art will recognize that other components and configurations can be used without parting from the spirit and scope of the invention.

The current invention may include a method, system, and/or computer program product for improving efficiency and addressing quality of care of intra-operative neurophysiologic monitoring (IONM) by monitoring technologist and physician resources, coupling the characteristics of the resources with requirements of individual cases and changing schedules, and rationally assigning the resources to the cases.

An exemplary embodiment of the present invention is directed to a method, system, and/or computer program product for monitoring in real time, activities of both technologists' and overseeing physicians' during remote connection and oversight of intra-operative neurophysiologic monitoring (IONM) data from IONM devices.

### Overview of Intraoperative Neurophysiologic Monitoring (IONM)

Intraoperative neurophysiologic monitoring (IONM) is the application of a variety of electrophysiological and vascular monitoring procedures during surgery to allow early warning and avoidance of injury to nervous system structures.

The purpose of IONM is to reduce the incidence of iatrogenic (i.e., arising from medical treatment) and randomly induced neurological injuries to patients during surgical procedures. IONM consequently confers benefits at many levels in medical care including improved patient care, reduced patient neurological deficits, improved surgical morbidity (e.g., decreasing the incidence or severity of surgery) and mortality, reduced hospital stay and medical costs and reduced overall insurance burden.

IONM may include administration of one or more of a variety of electrophysiological and vascular procedures or modalities during surgeries where nervous system structures are at risk. IONM procedures have evolved from the original use of single modality monitoring. Around 2001, most IONM equipment could acquire only two or four channels of information. In 2008, technology allows sixteen, or even thirty two, channels of data to be monitored for a single case. Even greater channels of data are expected in the near term. Somatosensory evoked potentials (SEEP) allow monitoring of the major sensory pathways. Motor evoked potentials, such as, e.g., transcranial electric motor-evoked potential (TceMEP), allow monitoring of the main motor pathways. Various other modalities are also available including, e.g., but not limited to, electroencephalography (EEG) (monitoring of the brain surface), electromyography (EMG), brain mapping (identification of specific areas of function) and transcranial doppler (monitoring brain blood flow), event related potentials (ERPs), brainstem auditory evoked response (BAER) or brainstem auditory evoked potential (BAEP), electroretinograms (ERG), visual evoked responses (VER or VEP) and electrocochleogram (EcOG). More than one modality may be used during a single surgery.

Monitoring is typically carried out in the operating room by a qualified technologist, supported by a neurologist either nearby, locally, or remotely, and in real time communication. Following the surgery, according to an exemplary embodiment, the data must be reviewed by the neurologist who then produces a summary report. The IONM data and summary report must be stored as part of the patient chart, in one exemplary embodiment.

Several IONM device manufacturers now produce multi-modality IONM monitoring devices for use in the operating room including, e.g., but not limited to, Cadwell Laboratories of Kennewick, Wash., USA; Xltek of Oakville, Ontario, Canada; Axon Systems, Inc. of Hauppauge, N.Y., USA; Nicolet Biomedical/Viasys Healthcare Inc. of Madison, Wis., USA; Cardinal Health of Dublin, Ohio, USA; Nihon Kohden of Tokyo, Japan; etc. Each of these manufacturers use proprietary, mutually incompatible and non-uniform, connectivity, storage and reporting techniques that are designed to collect information centered on each single case. The incompatibility of devices makes it difficult to use more than one type of equipment in any one institution. The many types of devices focused on single cases also impede collection of cumulative data for doing research and measuring quality of care. In most cases there is no provision for coupling the collection of data to any equipment, technologist or oversight physician performance-based information. In addition, some payer policies may vary by insurer and may require that overseeing physicians limit billing to a discrete number of cases being monitored simultaneously. Further, specific licensing, experience and institutional credentialing may be required of any individual overseeing physician to qualify for monitoring, of a specific case. Additionally, in exemplary embodiments, cases are often not scheduled ahead of time, are added on the fly, delayed in starting, or switched in order, etc.

More recently many hospitals have turned to outsourcing their IONM service due to the costs of maintaining an in-house program, lack of efficiencies of scale and difficulties in obtaining qualified personnel. Remote physician oversight is typically a requirement of the outsourced model to obtain efficiency. For IONM service providers now filling the remote oversight role and servicing several institutions, in more than one location, and with more than one machine type, and with personnel of varied experience and credentials, scheduling assignments is difficult. The problem of rationally assigning technologist and physician resources to cases that change scheduled starting times from minute to minute, while maintaining compliance and quality standards is greatly compounded. What is needed is a method of tracking these resources, in real time and coupling the characteristics of the resource with the requirements of individual cases and their changing schedules while optimizing performance.

According to an exemplary embodiment, a standardized method may be used to rationally assign cases to two or more overseeing physicians so as to optimize quality by load balancing and scheduling, while maintaining compliance with changing and varied guidelines and requirements. In an exemplary embodiment, case data may be coupled with other operational information such as, e.g., but not limited to, licensure, credentialing and insurer requirements, to assign resources automatically or semi-automatically according to a set of rules to improve efficiency and address quality of care.

### Exemplary Embodiment of an Exemplary Real Time Monitoring, Assignment, and Balancing IONM System

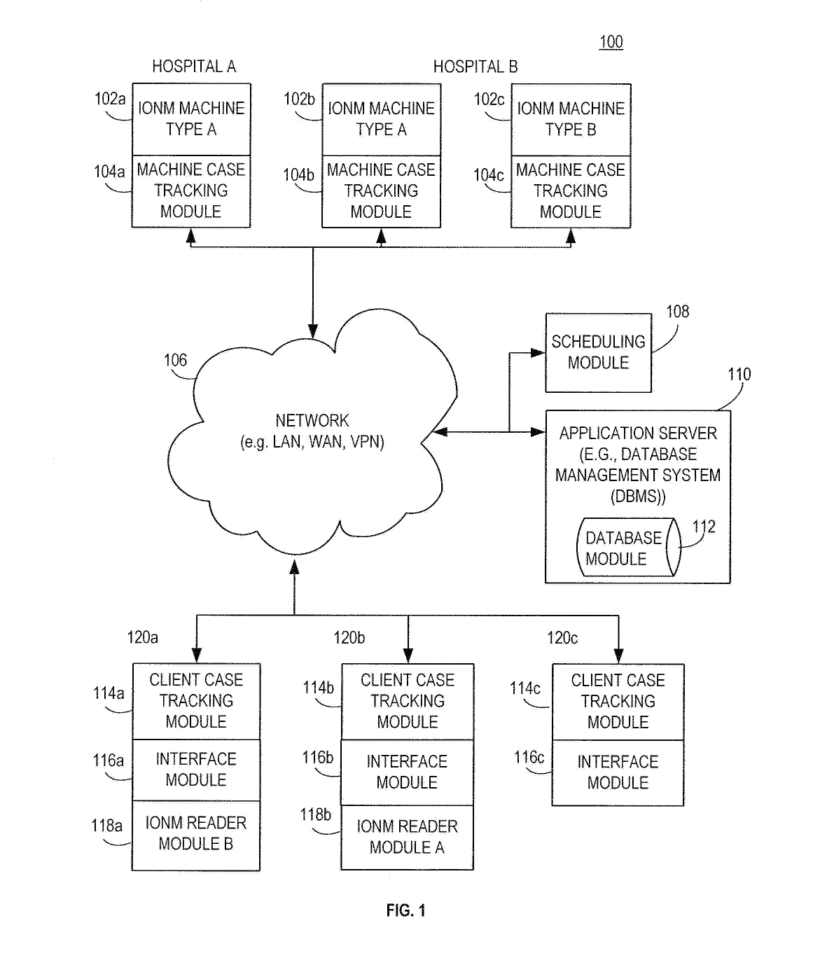

Referring to FIG. 1, diagram 100 provides a depiction of an exemplary data flow diagram of an exemplary hardware architecture illustrating an exemplary embodiment of a real time monitoring, assignment, and balancing IONM system.

According to an exemplary embodiment, one or more technologists (not shown) may operate one or more IONM devices at Hospital A (not shown) and Hospital B (not shown). In an exemplary embodiment, a variety of incompatible IONM device type machines 102a, 102b, and 102c (hereinafter collectively referred to as 102) may be used. For example, according to an exemplary embodiment, IONM device type A 102a may be used at Hospital A. In an exemplary embodiment, IONM device type A 102b, and IONM device type B 102c, may be used at Hospital B, as shown.

The IONM machines or IONM devices 102a, 102b, and 102c, may each have their own proprietary and incompatible data format. IONM data may be acquired from exemplary IONM equipment devices 102 during a surgical procedure.

IONM data monitored by the IONM equipment 102 may be extracted by exemplary machine case tracking modules (MCTM) 104a, 104b, and 104c (referred to hereinafter collectively as 104), according to an exemplary embodiment. In an exemplary embodiment, the MCTM 104 may log events that specify when a surgery has started, a surgery is underway, and when a surgery has ended.

In another exemplary embodiment, MCTM 104 may include a computer software program which may be resident on, and/or execute on a separate MCTM 104 device, and may interact directly or indirectly with software resident on, and/or executing on the IONM device 102. In another exemplary embodiment, MCTM 104 may be software which may execute on the IONM device 102, itself, while interacting with the software of the IONM device 102 (which is often proprietary) to interpret and transfer the acquired data into a standardized format. Each respective MCTM 104 may recognize each corresponding type of IONM device or machine 102 the MCTM 104 is interacting with, and may provide an appropriate algorithm for data extraction, translation, and/or conversion for real time monitoring. In another exemplary embodiment, the MCTM may interact with software providing such an algorithm and function. The MCTM 102 may also interact with (e.g., electronically) or prompt a monitoring technologist to perform certain interactions.

In an exemplary embodiment, the MCTM 104 may store the associated data for later access or transmission. Alternatively, MCTM 104 may communicate or transfer the data by, e.g., a secure electronic or optical communications link, connection or coupling such as, e.g., but not limited to, a virtual private network (VPN) over a network 106 to a centralized application server 110, where the data may be incorporated into a database module 112 of the server 110. According to an exemplary embodiment, for privacy and other reasons, data may be encrypted and security may be used to ensure patient and other sensitive information is protected.

In an exemplary embodiment, the database 112 may include data about upcoming or scheduled cases, current or in progress cases, and/or completed cases. The database 112 may also store or retrieve additional information such as, e.g., type of IONM device, type of device implanted in a patient, clinical information, patient information, patient identification information, billing information, insurance information, demographic information, medical record data, surgeon name, surgeon information, physician information, early outcome data, preoperative data, post-operative data, outcome scales, outcomes allowed, IONM event data, IONM event data tied to preoperative condition, IONM event data tied to postoperative condition, baseline data, IONM baseline data, anesthesiology data, changes in anesthesiology data, baseline anesthesiology data, ongoing anesthesiology data, scale preoperative data, scale postoperative data, alarms, information regarding key events during the surgery, information regarding key points of the surgery, comments made regarding the surgery, and/or other information regarding the surgery being monitored.

In an exemplary embodiment, the data may then be, e.g., but not limited to, immediately, or otherwise, made available to a scheduling module 108. According to an exemplary embodiment, the scheduling module 108 may allow a coordinator to distribute/plan work load effectively using optimization algorithms to automatically assign cases, semi-automatically assign cases, or advise personnel on assignment of cases. In an exemplary embodiment, the algorithms may be based upon one or more variables such as, e.g., but not limited to, number and/or type of active cases, number and/or type of upcoming cases, active physicians, scheduled physicians, physician credentials, physician licensures, physician consulting privileges, geographic location of the surgery, stage of surgery, key points of the surgery, key events during the surgery, or other variables associated with efficiency improvement, quality of care improvement and/or compliance to legal and clinical requirements. The scheduling module 108 may record upcoming and previously scheduled surgeries requiring intraoperative monitoring, according to an exemplary embodiment. The scheduling module 108 may include concurrency management for producing alarms when exceeding concurrency limits or warnings if concurrency limits are expected to be exceeded at some point during the day. According to an exemplary embodiment, the scheduling module 108 may be either proprietary or a separate commercially available software.

In an exemplary embodiment client case tracking modules (CCTM) 114a, 114b, and 114c (hereinafter collectively referred to as 114) and interface modules 116a, 116b, and 116c (hereinafter collectively referred to as 116) may execute on a client platform 120a, 120b, and 120c (collectively hereinafter referred to as 120) and may include a computer device used to access IONM data, track cases and/or manage cases. The interface module 116 may display relevant case information based upon who is running the interface module 116 and allow the user to manage their work. In an exemplary embodiment, the CCTM 114, may log when it is remotely connected, remotely monitoring, or stops remotely monitoring. According to an exemplary embodiment, the interface module 116 may display relevant case information based upon who is running the interface module 116 and allow the user to manage their work. According to an exemplary embodiment, the interface modules 116 may run on a computer with a IONM reading module 118a or 118b (hereinafter referred to collectively as 118), allowing IONM data to be viewed with the reading module 118. The interface module 116c may also run on any other computer without a reading module attached to the network 106, according to an exemplary embodiment. In other exemplary embodiments, the CCTM 114, interface module 116 and reader module 118 may be run, in any combination on one or more computers, or integrated in one or more software programs. According to an exemplary embodiment, the MCTM 102 and CCTM 114 may be the same case tracking module running in different modes.

According to an exemplary embodiment, the application server 110, although referred to as a server, need not be in a client-server relationship with modules 114, 116 and 118, but may use any other communications relationship such as, e.g., but not limited to, a peer-to-peer relationship. In an exemplary embodiment, the application server 110 may include a database management system (DBMS) in an exemplary embodiment. In one exemplary embodiment, the DBMS may be a MICROSOFT SQL SERVER available from MICROSOFT CORPORATION of Redmond, Wash., USA. Any of various other well known DBMSs may also be used such as, e.g., but not limited to, ORACLE, DB2, etc. Such data may be stored, e.g., in records including, e.g., one or more fields of data per data record. An exemplary database may be a relational database. Other databases may include a flat file, a hierarchical database, a Microsoft Access database, or even a spreadsheet. An exemplary and non-limiting data format is included in Table I, below.

In an exemplary embodiment the network 106 may be of any of various well known topologies, a ring, a bus, a star wired ring, an ethernet, token ring, FDDI, etc. Network 106 may be coupled to the scheduling module 108 or application server 110 via any of various well known technologies and devices (not shown), including, e.g., but not limited to, one or more router(s), firewall(s), load balancing device(s), web server(s), cabling, fibre, and/or multiplexer/demultiplexer, etc.

### Exemplary Embodiment of the Logical System of the Exemplary System

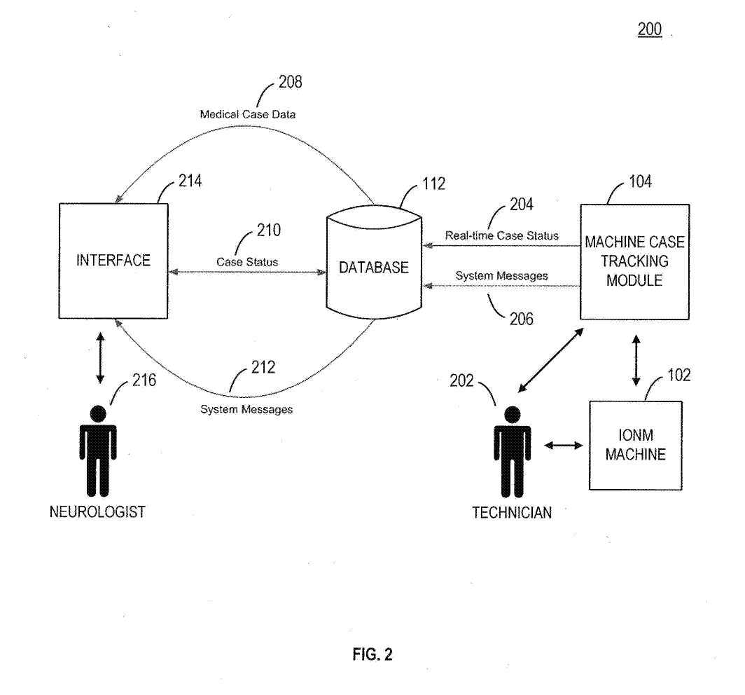

Referring to FIG. 2, a flow diagram 200 illustrates the flow of data within the system according to an exemplary embodiment. A technician 202 may use the IONM machine 102 and MCTM 104 to send real time case status data 204 and system messages 206 regarding a case to the server 110. The server 110 may send medical case data 208, case status data 210 and system messages 212 regarding a case to the interface 214, according to an exemplary embodiment. A neurologist 216, or physician, may interact with the interface 214 to monitor case data and provide input on the case, in an exemplary embodiment. The interface 214 may send its own data regarding the case status 210 to the server 110.

In an exemplary embodiment, the system may provide for communication management including allowing a technician 202 or intraoperative personnel to raise specific types of alarms, such as, e.g., but not limited to, “ready for physician to start monitoring case,” where such alarms could be directed to overseeing personnel 216 via the interface 214 or some other electronic communication such as, e.g., but not limited to, messaging or paging. Alarms may be raised by the overseeing personnel 216 such as, e.g., but not limited to, “anesthetic too high.” These alarms may be tracked as part of the patient medical record, according to an exemplary embodiment. An alarm may not only refer to negative information, but rather any and all medical case, user interface or message information. In another exemplary embodiment, there may be multiple levels of alarm severity dictating difference reactions, such as, e.g., but not limited to, do nothing, flash system tray icon, flash user interface text, flash standard message box, flash topmost message box, and/or flash sliding system tray panel, etc. According to an exemplary embodiment, messages may include an alarm level determining how it may be displayed.

In an exemplary embodiment, the system may provide for identification of key points of the surgery by intraoperative personnel 202 such as, e.g., but not limited to, patient preparation, opening, decompression of the spine, derotation of the spine, insertion of equipment, surgical manipulation, any major surgical intervention, any significant surgical intervention, closing, case completion, etc. According to an exemplary embodiment, the system may provide for identification of key events of the surgery either intraoperatively or by the overseeing personnel 214 such as, e.g., but not limited to, loss of signal, anesthetic affect on data, change in neurophysiological data suggesting patient injury, recovered signals, excessive electrical noise, etc. The system may also provide for the recording of case notes during the surgery including overseeing personnel comments on the case during surgery, and including comments, which may be available for reference in report production, according to an exemplary embodiment. In one exemplary embodiment, such comments may become part of the patient medical record. In another exemplary embodiment, support staff may also comment on the case during its course where such comments may be available to all involved on the case during and after surgery. According to an exemplary embodiment, such comments may be used to track communication or technical problems during the case. In another exemplary embodiment, these comments may be automatically inserted into a professional report, making it easier to edit comments and to submit a final report, with or without a final review. According to an exemplary embodiment, such comments may be incorporated into the database module 112. In an exemplary embodiment, all the above data may be tracked as part of the patient medical record creating an interactively constructed patient record during the patient's surgery. In an exemplary embodiment, once data is captured and aggregated, the data placed in database 112 may be used to run reports for such purposes as back office applications, billing, research, quality, etc. According to an exemplary embodiment, the interface 214 may inform the database 112 that a neurologist 216 has accepted to monitor an unmonitored surgery. In another exemplary embodiment, the server 110 may verify with the interface 214 that a surgery is being monitored by a neurologist 216. According to an exemplary embodiment, the server 110 may verify monitoring by the monitoring individual through measuring data collection time and activity including one or more of: a connection time; a communication interactions; a response to one or more prompts; or a parameter related to monitoring.

### Exemplary Embodiment of the Process System of the Exemplary System

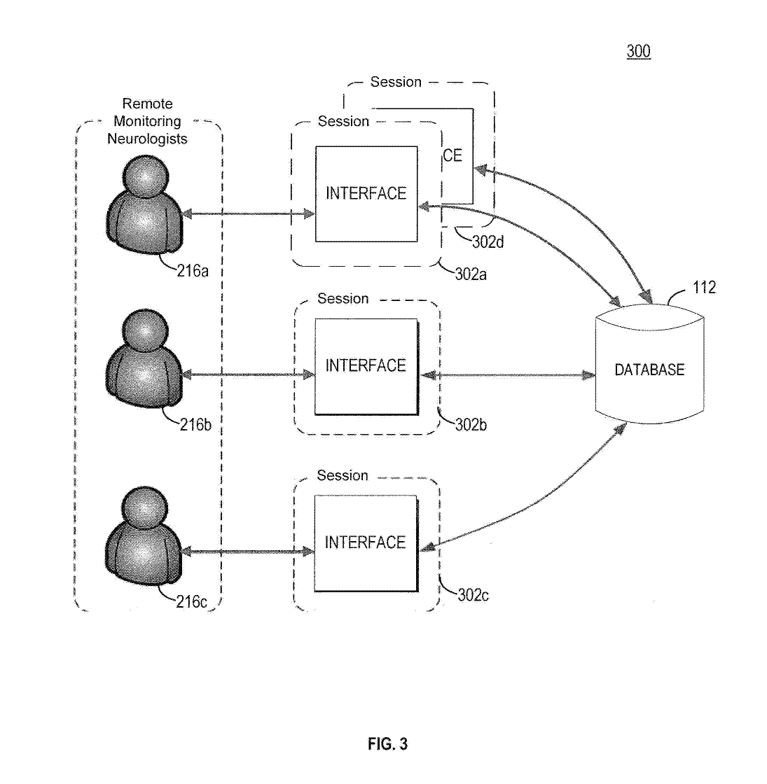

Referring to FIG. 3, a diagram 300 depicts an exemplary embodiment of multiple interface sessions according to an exemplary embodiment. The database 112 may be in communication with one or more interface sessions 302a, 302b, 302c, and 302d (collectively hereinafter referred to as 302), according to an exemplary embodiment. The interface sessions 302 may receive data regarding cases from the database 112 or send data regarding the cases back to the database 112. According to an exemplary embodiment, the interface sessions 302 may be interactively used by remote monitoring neurologists 216a, 216b, and 216c (hereinafter collectively referred to as 216). Neurologists 216 may view data from the database 112 sent to the interface session 302 and may use the interface sessions 302 to send data, such as, e.g., but not limited to, alarms or comments, to the database 112. In an exemplary embodiment, neurologists 216 may use zero, one 302c and 302b, or multiple 302d interface sessions to monitor cases.

### Exemplary Embodiment of the User Interface

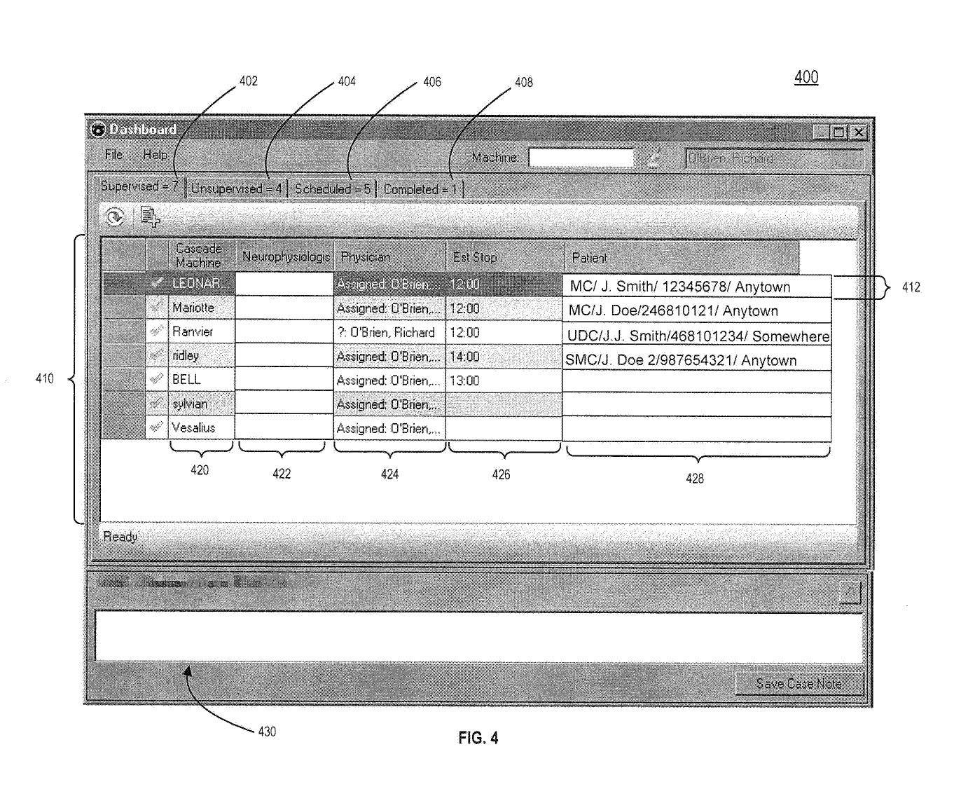

FIG. 4 depicts an exemplary embodiment of the user interface 400 of an overseeing physician according to an exemplary embodiment. According to an exemplary embodiment, the user interface 400 may display real-time medical case information for cases relevant to the current user. The filters determining relevancy may be obtained from the database 112. In an exemplary embodiment, the user interface 400 may include tabbed windows, such as, e.g., but not limited to, a “Supervised” cases tab 402, a “Unsupervised” cases tab 404, a “Scheduled” cases tab 406, or a “Completed” cases tab 408. According to an exemplary embodiment, the user interface 400 may clearly separate and display cases according to their status. In an exemplary embodiment, each tab may include a table 410 with each row 412 representing a case and each column of the row representing data regarding the case, such as, e.g., but not limited to, IONM Machine name 420, name of working neurophysiologist 422, name of working physician 424, estimated case stop time 426, or patient information 428. According to an exemplary embodiment, patient information 428 may be a variety of information such as, e.g., but not limited to, name of hospital, name of patient, patient identification number, or location of hospital. The user interface 400 may provide an area for a user to enter case notes 430, according to an exemplary embodiment. In another exemplary embodiment, the user interface 400 may display an event history of user or system actions in a chronological list. These actions array be limited to key events such as, e.g., but not limited to, case status changes (e.g. from “unsupervised” to “supervised”), messages received from surgery, acceptance of cases, etc. According to an exemplary embodiment, the user interface 400 may provide a history of all alarms in a sortable grid with the ability to jump to an alarm item's current location. According to an exemplary embodiment, in circumstances where there may be too much information to contain in an alarm history record, a mechanism may be provided for displaying detailed alarm information. In an exemplary embodiment, the neurologist use case of the user interface 400 may include: enter notes, view case, accept case, view alarm, view message, and view events. According to an exemplary embodiment, the user interface 400 may have a clinical and administrative user role, where clinical users have access to all user interface features excluding administrative features. An exemplary, but non limiting, listing of inputs and outputs for requesting case data for an exemplary interface is included in Table II, below. An exemplary, but non limiting, listing of inputs and outputs for an exemplary alarm is included in Table III, below. An exemplary, but non limiting, listing of inputs and outputs for getting messages from an exemplary interface is included in Table IV, below. An exemplary, but non limiting, listing of inputs and outputs for retrieving event history for an exemplary interface is included in Table V, below.

### Exemplary Embodiment of a Flow Chart of a Cast Start

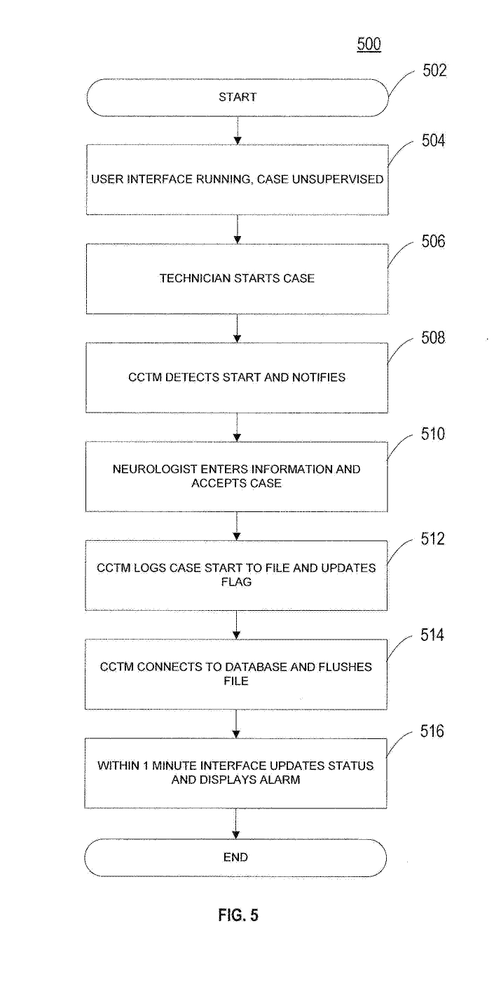

FIG. 5 depicts an exemplary embodiment of a flow chart 500 of a case start according to an exemplary embodiment. The flow chart 500 shows an exemplary real-time case status change for starting a case, resulting in the user interface 400 displaying a new case status and alarm within one minute of a case status change. In block 504, the user interface 400 is running and there is a case with a status of unsupervised. According to an exemplary embodiment, in block 506, the field technician may start a case. The case may be performed using, e.g., but not limited to, a Cadwell Cascade multi-modality system, software and IONM device 102, running CASCADE® proprietary software available from Cadwell Laboratories, Inc. of Kennewick, Wash. USA. In block 508, the CCTM 114 may detect the case start and display a dialog using the user interface 400 indicating at least the start to the neurologist 216, in an exemplary embodiment. In block 510, the neurologist 216 may enter case information, such as, but not limited to, e.g., identifying it as case 1 and clicking “OK” using the user interface 400. According to an exemplary embodiment, in block 512, the CCTM 114 may log a “case started” event to a file and set an update flag. In block 514, the CCTM 114 may connect to the database 112 and flush the file. In the exemplary embodiment, in block 516, within one minute, the user interface 400 may update the case status to “Supervised” and display a flashing alarm.

### Exemplary Embodiment of a Case Sequence Diagram

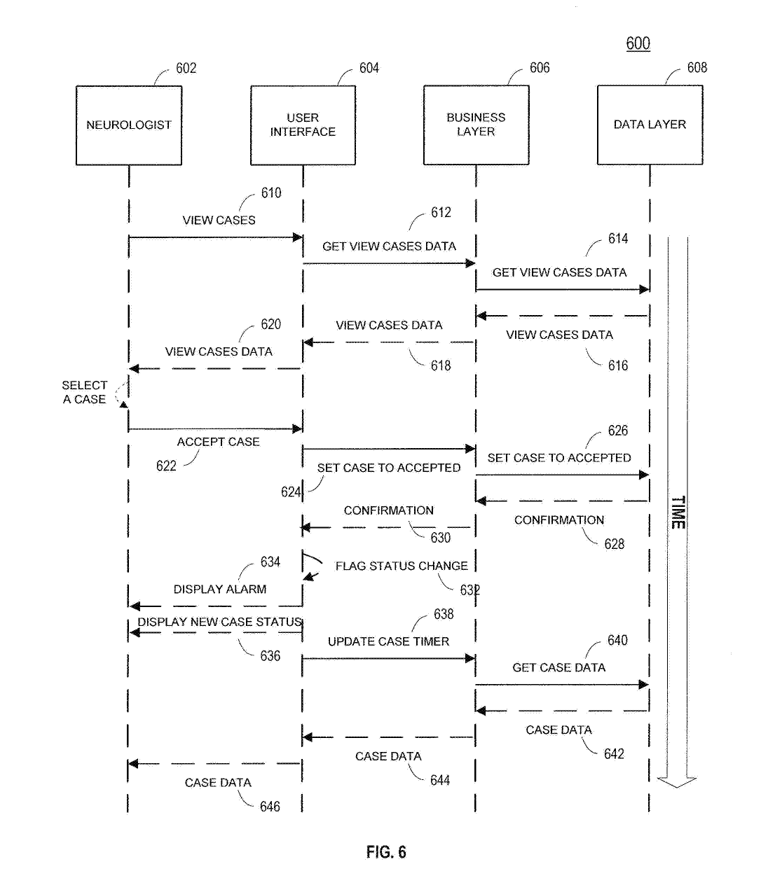

FIG. 6 depicts an exemplary embodiment of a sequence diagram 600 for viewing, accepting and updating a case according to an exemplary embodiment. The diagram 600 encompasses four exemplary objects, a neurologist 602, a user interface 604, a business layer 606, and a data layer 608. According to the exemplary embodiment, the neurologist 602 may begin by issuing the command to view cases 610 to the user interface 604. The user interface 604 may then send a “GET VIEW CASES DATA” request 612 to the business layer 606. In an exemplary embodiment, the business layer 606 may then send a corresponding request 614 to the data layer 608. The data layer 608 may then retrieve and send the view cases data 616 to the business layer 606, which may send the view cases data 618 to the user interface 604 and allow the neurologist 602 to view the view cases data 620. According to an exemplary embodiment, the neurologist 602 may then use the user interface 604 to select and accept a case 622. The user interface 604 may then send a “SET CASE TO ACCEPTED” request 624 to the business layer 606, which may send a “SET CASE TO ACCEPTED” request 626 to the data layer 608, in an exemplary embodiment. The data layer 608 may then set the case to accepted and send a confirmation 628 to the business layer 606, which may send a confirmation 630 to the user interface 604. According to an exemplary embodiment, the user interface 604 may then flag a status change 632 in the case and display an alarm 634 with the new case status 636 to the neurologist 602. In an exemplary embodiment, the interface 604 may then send an “UPDATE CASE TIMER” 638 request to the business layer 606 which may send a “GET CASE DATA” 640 request to the data layer 608 at the appropriate time. According to an exemplary embodiment, the data layer 608 may then send the requested case data 642 to the business layer 606, which may then send the case data 644 to the user interface 604 which may display the case data 646 to the neurologist 602.

### Exemplary Embodiment of Computer Environment

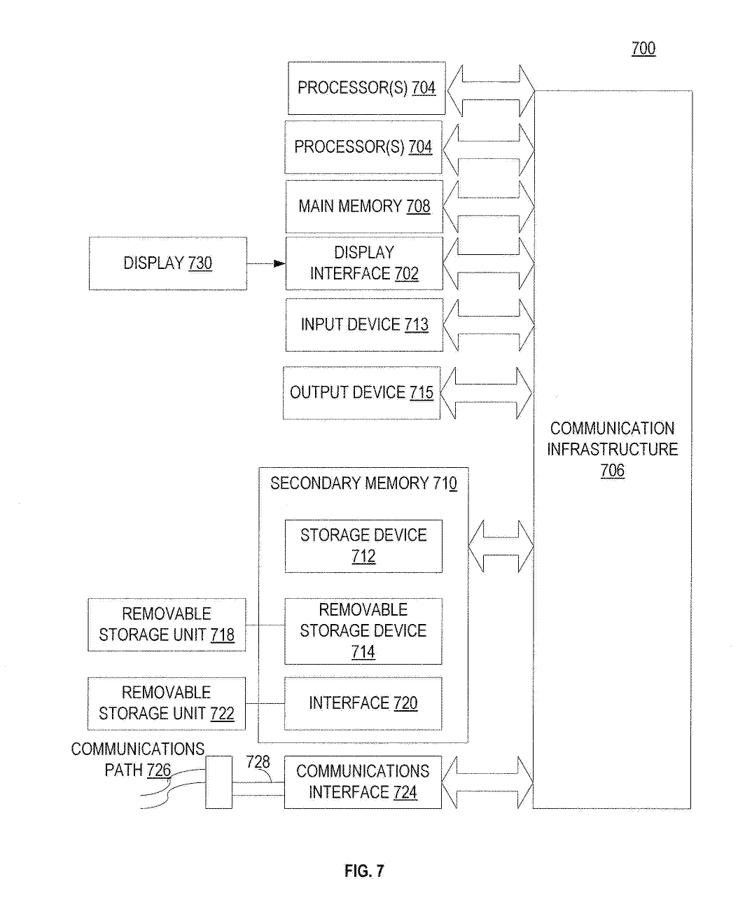

FIG. 7 depicts an exemplary computer system that may be used in implementing an exemplary embodiment of the present invention. Specifically, FIG. 7 depicts an exemplary embodiment of a computer system 700 that may be used in computing devices such as, e.g., but not limited to, a client and/or a server, etc., according to an exemplary embodiment of the present invention. FIG. 7 depicts an exemplary embodiment of a computer system that may be used as a client platform 120, an IONM machine 102, application server 110, client device 700, or a server device 700, a peer-to-peer device, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 700 may be shown in FIG. 7, depicting an exemplary embodiment of a block diagram of an exemplary computer system useful for implementing the present invention. Specifically, FIG. 7 illustrates an example computer 700, which in an exemplary embodiment may be, e.g., (but not limited to) a personal computer (PC) system running an operating system such as, e.g., (but not limited to) MICROSOFT® WINDOWS® NT/98/2000/XP/CE/ME/VISTA, etc. available from MICROSOFT® Corporation of Redmond, Wash., USA. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 700 may be shown in FIG. 7. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 7. Services may be provided on demand using, e.g., but not limited to, an interactive television (iTV), a video on demand system (VOD), and via a digital video recorder (DVR), or other on demand viewing system.

The computer system 700 may include one or more processors, such as, e.g., but not limited to, processor(s) 704. The processor(s) 704 may be connected to a communication infrastructure 703 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 700 may include a display interface 702 that may forward, e.g., but not limited to, graphics, text, and other data, etc., from the communication infrastructure 703 (or from a frame buffer, etc., not shown) for display on the display unit 730.

The computer system 700 may also include, e.g., but may not be limited to, a main memory 708, random access memory (RAM), and a secondary memory 710, etc. The secondary memory 710 may include, for example, (but not limited to) a hard disk drive 712 and/or a removable storage drive 714, representing a floppy diskette drive, a magnetic tape drive, an optical disk drive, a compact disk drive CD-ROM, etc. The removable storage drive 714 may, e.g., but not limited to, read from and/or write to a removable storage unit 718 in a well known manner. Removable storage unit 718, also called a program storage device or a computer program product, may represent, e.g., but not limited to, a floppy disk, magnetic tape, optical disk, compact disk, etc. which may be read from and written to by removable storage drive 714. As may be appreciated, the removable storage unit 718 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 722 and interfaces 720, which may allow software and data to be transferred from the removable storage unit 722 to computer system 700.

Computer 700 may also include an input device 713 such as, e.g., (but not limited to) a mouse or other pointing device such as a digitizer, scanner, touchscreen, and a keyboard or other data entry device.

Computer 700 may also include output devices 715, such as, e.g., (but not limited to) display 730, and display interface 702. Other output devices may include, e.g., but not limited to, printers, touchscreen, projectors, screens, etc.

Computer 700 may further include any of various other well known input/output (I/O) devices such as, e.g., (but not limited to) communications interface 724, cable 728 and communications path 723, routers, firewalls, and load balancing and/or other equipment (not shown), etc. These devices may include, e.g., but not limited to, a network interface card, and modems (neither are labeled). Communications interface 724 may allow software and data to be transferred between computer system 700 and external devices.

### Exemplary Definitions

In this document, the teems “computer program medium” and “computer readable medium” may be used to generally refer to media such as, e.g., but not limited to removable storage drive 714, a hard disk installed in hard disk drive 712, and signals 728, etc. These computer program products may provide software to computer system 700, The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

In describing the invention, the following definitions may be applicable throughout (including above).

A “network” may refer to a number of computers and associated devices that may be coupled and/or connected by communication facilities. A network may involve permanent connections such as cables or temporary connections such as those that may be made through telephone or other communication links. A network may further include hard-wired connections (e.g., coaxial cable, twisted pair, optical fiber, waveguides, etc.) or wireless connections (e.g., radio frequency waveforms, free-space optical waveforms, acoustic waveforms, satellite transmissions, infrared communications, wireless communications, line-of-sight, etc.). Examples of a network may include: an internet, such as the worldwide Internet; an intranet; a local area network (LAN); a wide area network (WAN); a metropolitan area network; a personal area network; a wireless network; a private and/or public network; and a combination of networks, such as, e.g., but not limited to, an internet and an intranet. Exemplary networks may operate with any of a number of protocols, such as, e.g., but not limited to, Internet protocol (IP), transmission control protocol (TCP), asynchronous transfer mode (ATM), or synchronous optical network (SONET), user datagram protocol (UDP), IEEE 802.x, 802.11, 802.16, etc.

A “computer” may refer to one or more apparatus or one or more systems that are capable of accepting a structured input, processing the structured input according to prescribed rules, and producing results of the processing as output. Examples of a computer may include: a computer; a stationary or portable computer; a computer having a single processor, multiple processors, or multi-core processors, which may operate in parallel or not in parallel; a general purpose computer; a special purpose computer; a supercomputer; a mainframe; a super mini-computer; a mini-computer; a workstation; a micro-computer; a server; a client; an interactive television; a web appliance; a thin client; a fat client; a network appliance; a communications device; a telecommunications device with internet access; a hybrid combination of a computer and an interactive television; a portable computer; a tablet personal computer (PC); a personal digital assistant (PDA); a portable device; a portable telephone; a telephony device; application-specific hardware to emulate a computer or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC) or a multiprocessor system-on-chip (MPSoC) an optical computer; a quantum computer; a biological computer; and an apparatus that may accept data, may process data in accordance with one or more stored software programs, may generate results, and typically may include input, output, storage, arithmetic, logic, and/or control units.

“Software” may refer to prescribed rules, modules, logic, code, instructions, applications, etc., to operate a computer or a portion of a computer. Examples of software may include, e.g., but are not limited to: applications; routines; modules; objects; classes; object-oriented code; JAVA; methods; functions; code segments; instructions; applets; source code; object code; executable code; pre-compiled code; compiled code; interpreted code; computer programs; and/or programmed logic.

A “computer-readable medium” may refer to any storage device used for storing data accessible by a computer. Examples of a computer-readable medium may include, e.g., but are not limited to: a magnetic hard disk; a floppy disk; an optical disk, such as a CD-ROM and a DVD; a magnetic tape; a memory chip; magneto-optical devices; write once read many (WORM); a storage area network (SAN); a volume; a virtual disk; or other types of media that can store machine-readable instructions thereon.

A “computer system” may refer to a system which may include, one or more computers, where each computer may include a computer-readable medium embodying software to operate the computer. Examples of a computer system may include, e.g., but may not be limited to: a distributed computer system for processing information via computer systems linked by a network; two or more computer systems connected or coupled together via a network or other communications device for transmitting or receiving information between the computer systems; and one or more apparatuses or one or more systems that may accept data, may process data in accordance with one or more stored software programs, may generate results, and typically may include, e.g., but not limited to, input, output, processing, storage, branching, arithmetic, logic, and/or control units.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

### Exemplary Real Time Monitoring, Assignment, and Balancing Database

TABLE I

| Table | Column |
|---|---|
| Active_Cases | ActiveCasesID |
| Active_Cases | assistanceRequestActive |
| Active_Cases | assistanceRequestCancelled |
| Active_Cases | assistanceRequested |
| Active_Cases | birthdate |
| Active_Cases | caseAppended |
| Active_Cases | caseComplete |
| Active_Cases | caseID |
| Active_Cases | caseRestarted |
| Active_Cases | caseRunning |
| Active_Cases | caseStarted |
| Active_Cases | caseTimeout |
| Active_Cases | diagnosis |
| Active_Cases | estMonitorEnd |
| Active_Cases | estMonitorStart |
| Active_Cases | firstEvent |
| Active_Cases | lastEvent |
| Active_Cases | machine |
| Active_Cases | orRoom |
| Active_Cases | patientFirstName |
| Active_Cases | patientID |
| Active_Cases | patientLastName |
| Active_Cases | readyForHistory |
| Active_Cases | scheduleID |
| Active_Cases | smdAccessed |
| Active_Cases | smdCreated |
| Active_Cases | smdFile |
| Active_Cases | smdModified |
| Active_Cases | surgeon |
| Active_Cases | surgicalProcedure |
| Active_Cases | technologist |
| Active_Cases | user |
| Active_Cases_History | ActiveCasesHistoryID |
| Active_Cases_History | ActiveCasesID |
| Active_Cases_History | birthdate |
| Active_Cases_History | caseAppended |
| Active_Cases_History | caseComplete |
| Active_Cases_History | caseID |
| Active_Cases_History | caseRestarted |
| Active_Cases_History | caseRunning |
| Active_Cases_History | caseStarted |
| Active_Cases_History | caseTimeout |
| Active_Cases_History | diagnosis |
| Active_Cases_History | estMonitorEnd |
| Active_Cases_History | estMonitorStart |
| Active_Cases_History | firstEvent |
| Active_Cases_History | lastEvent |
| Active_Cases_History | machine |
| Active_Cases_History | movedToHistory |
| Active_Cases_History | orRoom |
| Active_Cases_History | patientFirstName |
| Active_Cases_History | patientID |
| Active_Cases_History | patientLastName |
| Active_Cases_History | scheduleID |
| Active_Cases_History | smdAccessed |
| Active_Cases_History | smdCreated |
| Active_Cases_History | smdFile |
| Active_Cases_History | smdModified |
| Active_Cases_History | surgeon |
| Active_Cases_History | surgicalProcedure |
| Active_Cases_History | technologist |
| Active_Cases_History | user |
| Case_Note | Added_By |
| Case_Note | Case_Note_ID |
| Case_Note | Date_Added |
| Case_Note | Employee_ID |
| Case_Note | Note |
| Case_Note | Private_Note |
| Case_Note | ScheduleID |
| Case_Note_History | Added_By |
| Case_Note_History | Case_Note_History_ID |
| Case_Note_History | Date_Added |
| Case_Note_History | Employee_ID |
| Case_Note_History | Note |
| Case_Note_History | Private_Note |
| Case_Note_History | ScheduleID |
| Case_Tracker | Approved_Version |
| Case_Tracker | Case_Tracker_ID |
| Case_Tracker | Cutoff_Date |
| Event_Messages_History | AddedBy |
| Event_Messages_History | CaseID |
| Event_Messages_History | DateAdded |
| Event_Messages_History | EventMessagesHistoryID |
| Event_Messages_History | EventMessagesID |
| Event_Messages_History | Machine |
| Event_Messages_History | Message |
| Event_Messages_History | MessageTime |
| Event_Messages_History | MessageType |
| Event_Messages_History | movedToHistory |
| Event_Messages_History | Transfer_Complete |
| Event_Messages_History | Transfer_Date |
| Event_Messages_History | Transfer_Started |
| EventMessages | AddedBy |
| EventMessages | CaseID |
| EventMessages | DateAdded |
| EventMessages | EventMessagesID |
| EventMessages | Machine |
| EventMessages | Message |
| EventMessages | MessageTime |
| EventMessages | MessageType |
| EventMessages | readyForHistory |
| EventMessages | Transfer_Complete |
| EventMessages | Transfer_Date |
| EventMessages | Transfer_Started |
| Machines | Case_Tracker_Version |
| Machines | Machine_Name |
| Machines | Machines_ID |
| Machines | Techform_Version |
| Remote_Cases | birthdate |
| Remote_Cases | caseID |
| Remote_Cases | diagnosis |
| Remote_Cases | firstEvent |
| Remote_Cases | lastEvent |
| Remote_Cases | machine |
| Remote_Cases | orRoom |
| Remote_Cases | patientFirstName |
| Remote_Cases | patientID |
| Remote_Cases | patientLastName |
| Remote_Cases | readyForHistory |
| Remote_Cases | RemoteCasesID |
| Remote_Cases | remoteComplete |
| Remote_Cases | remoteMachine |
| Remote_Cases | remoteRunning |
| Remote_Cases | remoteStarted |
| Remote_Cases | remoteTimeout |
| Remote_Cases | scheduleID |
| Remote_Cases | smdFile |
| Remote_Cases | surgeon |
| Remote_Cases | surgicalProcedure |
| Remote_Cases | technologist |
| Remote_Cases | user |
| Remote_Cases_History | birthdate |
| Remote_Cases_History | caseID |
| Remote_Cases_History | diagnosis |
| Remote_Cases_History | firstEvent |
| Remote_Cases_History | lastEvent |
| Remote_Cases_History | machine |
| Remote_Cases_History | movedToHistory |
| Remote_Cases_History | orRoom |
| Remote_Cases_History | patientFirstName |
| Remote_Cases_History | patientID |
| Remote_Cases_History | patientLastName |
| Rernote_Cases_History | RemoteCasesHistoryID |
| Remote_Cases_History | RemoteCasesID |
| Remote_Cases_History | remoteComplete |
| Remote_Cases_History | remoteMachine |
| Remote_Cases_History | remoteRunning |
| Remote_Cases_History | remoteStarted |
| Remote_Cases_History | remoteTimeout |
| Remote_Cases_History | scheduleID |
| Remote_Cases_History | smdFile |
| Remote_Cases_History | surgeon |
| Remote_Cases_History | surgicalProcedure |
| Remote_Cases_History | technologist |
| Remote_Cases_History | user |
| Schedule | CallbackRequired |
| Schedule | Case_ID |
| Schedule | Case_Number |
| Schedule | Case_Status |
| Schedule | Hospital_ID |
| Schedule | Length_Of_Surgery |
| Schedule | NotificationSent |
| Schedule | Sch_Date_of_Surgery |
| Schedule | Sch_Diagnosis |
| Schedule | Sch_End_of_Surgery |
| Schedule | Sch_Instructions |
| Schedule | sch_original_date_of_surgery |
| Schedule | Sch_Other_Services |
| Schedule | Sch_Patient_DOB |
| Schedule | Sch_Patient_Name |
| Schedule | Sch_Surgical_Procedure |
| Schedule | Sch_Type_of_Surgery |
| Schedule | ScheduleID |
| Schedule | Surgeon_ID |
| Schedule | Surgery_End |
| Schedule | training_opportunity |
| Schedule_Employee | Assigned_By |
| Schedule_Employee | Assigned_Role |
| Schedule_Employee | Confirmed |
| Schedule_Employee | Employee_ID |
| Schedule_Employee | End_DateTime |
| Schedule_Employee | Notified |
| Schedule_Employee | ScheduleID |
| Schedule_Employee | Start_DateTime |
| Upload_Details | Billing_Prep_Complete |
| Upload_Details | Billing_Prep_Started |
| Upload_Details | Case_Rejected |
| Upload_Details | Case_Rejected_Minutes |
| Upload_Details | Case_Reviewed |
| Upload_Details | Invoice_Delivered |
| Upload_Details | Invoice_Number |
| Upload_Details | Modality_Error_On_Upload |
| Upload_Details | Monitoring_Neurologist_ID |
| Upload_Details | Neurologist_Involvement |
| Upload_Details | Patient_Event |
| Upload_Details | patient_name |
| Upload_Details | Primary_Tech_ID |
| Upload_Details | Relief_Neurologist_ID |
| Upload_Details | Relief_Tech_ID |
| Upload_Details | Report_Faxed |
| Upload_Details | Report_Path |
| Upload_Details | Report_Printed |
| Upload_Details | Report_Requested_ASAP |
| Upload_Details | Report_Submitted |
| Upload_Details | Reporting_Neurologist_ID |
| Upload_Details | ScheduleID |
| Upload_Details | Service_Date |
| Upload_Details | Techform_Version |
| Upload_Details | Upload_Attempts |
| Upload_Details | Upload_Complete |
| Upload_Details | Upload_Details_ID |
| Upload_Details | Upload_Machine |
| Upload_Details | Upload_Path |
| Upload_Details | Upload_Restarted |
| Upload_Details | Upload_Size |
| Upload_Details | Upload_Started |
| Upload_Details | username |

### Exemplary Get Case Data Inputs & Outputs

TABLE II

| Direction | Value | Data type | Description |
|---|---|---|---|
| Input | Type | Varchar(15) | Type of cases to get |
| Output | CaseID | Int | |
| | Date | Datetime | Date the operation is scheduled for |
| | Cascade Machine | Varchar(50) | Host name of the PC running Cascade at the |
| | Name | | hospital |
| | Status | Int | Case status (started, running, stopped) |
| | Remote Status | Int | Remote status (started, running, stopped) |
| | Estimated Start Time | Datetime | Time the Case Started event was logged. |
| | Stop Time | | Time the Case Stopped event was logged. |
| | | | If a case is running, show its estimated stop |
| | | | time, otherwise show the actual stop time |
| | Patient Name | Varchar(50) | |
| | Surgeon Name | Varchar(50) | Operating surgeon |
| | Technician Name | Varchar(50) | Technician operating Cascade in the field |
| | OR Room | | |
| | Region | | |
| | Hospital Code | Char(10) | |

### Exemplary Alarm Inputs & Outputs

TABLE III

| Direction | Value | Data type | Description |
|---|---|---|---|
| Input | N/A | | |
| Output | AlarmID | Varchar(30) | Unique alarm name |
| | Level | Int | What action to take. |
| | | | Actions are defined in |
| | | | the Dashboard. |

### Exemplary Message Inputs & Outputs

TABLE IV

| Direction | Value | Data type | Description |
|---|---|---|---|
| Input | N/A | | |
| Output | EventID | Int | |
| | Time | Datetime | Time the event occurred |
| | Name | Varchar(30) | Event name or short |
| | | | description for context |
| | Details | Varchar(255) | Full recount of what happened |

### Exemplary Event History Input & Outputs

TABLE V

| Direction | Value | Data type | Description |
|---|---|---|---|
| Input | StartDate | Datetime | Return events after this date |
| | EndDate | Datetime | Return events before this date |
| Output | EventID | Int | |
| | Time | Datetime | Time the event occurred |
| | Name | Varchar(30) | Event name or short |
| | | | description for context |
| | Details | Varchar(255) | Full recount of what happened |

What is claimed is:

1. A computer-implemented method of monitoring in real time, activities of a monitoring individual during remote connection and oversight of intra-operative neurophysiologic monitoring (IONM) data from a plurality of IONM devices of at least one machine type, comprising:
receiving IONM data from at least one IONM device regarding a surgery being monitored;
receiving patient data about at least one patient;
storing case data in a computer database, said case data comprising information regarding at least one of said patient data or said IONM data;
scheduling the monitoring individual to a specific surgery case based on said case data; and
providing said case data to the monitoring individual.
